(19) United States
(12) Patent Application Publication
(10) Pub. No.: US 2024/0262392 A1
(43) Pub. Date: Aug. 8, 2024

(54) AUTONOMOUS VEHICLE FOLLOW MODE

(71) Applicant: GM Cruise Holdings LLC, San Francisco, CA (US)

(72) Inventor: Daniel Kan, Atlantic Beach, FL (US)

(21) Appl. No.: 18/164,978

(22) Filed: Feb. 6, 2023

(51) Int. Cl. B60W 60/00; G06V 20/58

(52) U.S. Cl. CPC B60W 60/0027; G06V 20/584; B60W 2420/403; B60W 2554/4044; B60W 2556/45

(57) ABSTRACT

Aspects of the disclosed technology provide solutions for resolving navigation challenges and in particular, for providing autonomous vehicle (AV) navigation assistance by enabling the AV to follow other road vehicles. A process of the disclosed technology can include steps for identifying an autonomous vehicle (AV) navigation challenge, establishing a connection to a remote assistance (RA) system based on the identified challenge, and transmitting AV perception data to the RA system. In some aspects, the process can further include steps for receiving, from the RA system, a follow car command, wherein the follow car command identifies a target vehicle from among the one of the one or more vehicles in the environment; and updating a trajectory of the AV to cause the AV to follow the target vehicle. System and machine-readable media are also provided.

### BACKGROUND

### 1. Technical Field

The present disclosure generally relates to solutions for resolving navigation challenges and in particular, for providing autonomous vehicle (AV) navigation assistance by enabling an AV to follow other entities, such as road vehicles, for example, to circumnavigate obstacles.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning, and obstacle avoidance.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example environment in which autonomous vehicle (AV) navigation can be facilitated by following another road vehicle (e.g., a target vehicle), according to some aspects of the disclosed technology.

FIG. 2 illustrates a signaling diagram of example communications between an AV and a Remote Assistance (RA) system, according to some aspects of the disclosed technology.

FIG. 3 illustrates an example process for providing navigation assistance to an AV, according to some aspects of the disclosed technology.

FIG. 4 illustrates an example system environment that can be used to facilitate autonomous vehicle (AV) dispatch and navigation operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicle (AV) navigation systems are designed to collect data about a surrounding environment and to reason about objects/entities represented therein for the purpose of making routing and navigation decisions. In some instances, AV navigation systems may encounter or may experience a navigation challenge, and may thereby be unable to decide a course of action, for example, when the AV encounters novel objects or scenarios that frustrate perception, prediction, and/or planning operations. In these situations, the AV can be configured to request assistance from a Remote Assistance (RA) operator that can provide support necessary to resolve the challenge. By way of example, navigation challenges may occur when an AV encounters a novel driving scenario, such as a construction road closure, through which a path plan cannot be determined by the AV's planning layer. In such instances, the AV's navigation may be aided by instructions received from a remote operator, for example, that can provide commands and/or instructions to the AV, indicating maneuvers and/or paths to navigate through (or around) the road closure.

To improve AV operations in such instances, it would be helpful to leverage information provided by the actions of other entities, such as other traffic participants, to determine optimal actions and/or a corrective path for the AV. Aspects of the disclosed technology provide solutions for correcting/fixing AV navigation errors by providing AVs with the ability to follow specific entities and/or entity trajectories, for example, that safely navigate around (or through) the problematic driving scenario. In some aspects, the AV can be configured to automatically establish a connection with an RA operator (e.g., via a remote assistance system), and to receive commands (e.g., a follow vehicle command) that indicates a target vehicle and/or target vehicle trajectory that the AV should follow to resolve the navigation challenge. Depending on the desired implementation, the follow vehicle command may specify other types of entities/traffic participants that the AV should follow, including but not limited to: motorcycles, bicycles, scooters, and/or pedestrians, etc. As such, although several of the examples discussed herein relate scenarios in which an AV is instructed to follow another vehicle/car, it is understood that the AV may be configured to follow virtually any dynamic (moving) entity that can be observed in the AV's driving environment. In some implementations, the AV can continue to follow the target vehicle until receipt of a subsequent instruction (e.g., an unfollow command) that causes the AV to stop following the target vehicle. In other implementations, the AV may automatically determine when to stop following the target vehicle, for example, if a trajectory of the target vehicle deviates from the routing/destination instructions of the AV, and/or after the expiration of a predetermined time period.

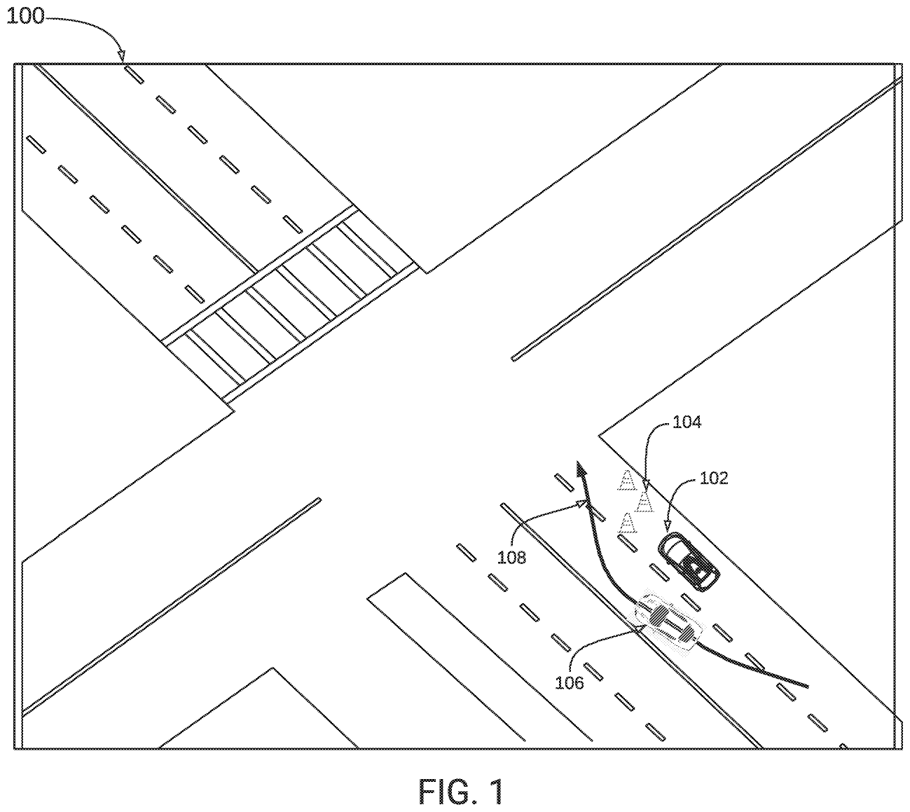

FIG. 1 illustrates an example environment 100 in which autonomous vehicle (AV) navigation can be facilitated by following another road vehicle (e.g., target vehicle 106). In the example of environment 100, the navigation operations of AV 102 have halted, e.g., due to an encounter with obstruction 104 (road cones) that cannot be successfully circumnavigated by AV 102.

In operation, AV 102 can be configured to automatically detect the navigation challenge, and to contact a remote assistance (RA) operator that can provide instructions to AV 102 in order to resolve the navigation dilemma. To facilitate support by the RA operator, the AV may automatically provide various forms of telemetry to the operator to apprise the operator of the scene in which the navigation challenge occurred. Depending on the desired implementation the provided AV telemetry may include perception data (such as sensor data) representing an environment around the AV, including various entities, such as other traffic participants. In some aspects, telemetry from the AV's software stack may also be included in the perception data, for example, to indicate bounding boxes around objects in the environment, associated semantic labels, kinematic data about other traffic participants and/or objects, and the like. By way of example, the perception data may include historic and/or predicted vehicle trajectory information for other vehicles, such as trajectory 108 of vehicle 106, that is actively navigating through the environment 100, and importantly, successfully navigating around obstruction 104.

In some aspects, AV 102 may receive a follow command (also referred to herein as a follow vehicle or follow car command) that contains information indicating an entity, vehicle and/or vehicle path that AV 102 can follow to circumnavigate obstruction 104. That is, the vehicle follow command may contain information identifying vehicle 106 and/or trajectory 108 as a viable route for AV 102 to navigate around obstruction 104. In some aspects, trajectories indicated by the follow command may be computed or derived from the paths of multiple entities (e.g., vehicles, bicycles, scooters, and/or pedestrians, etc.), for example, that have been observed by AV 102 to navigate around/through the problematic scenario, e.g., obstruction 104.

In some implementations, AV 102 may be configured to automatically identify target vehicle 106 and/or trajectory 108 and to initiate following, e.g., based on telemetry collected/generated locally at the AV. In such instances, initialization of vehicle following operations may need to be approved by the RA operator. In other approaches, the AV may be configured to automatically select a vehicle to follow (e.g., vehicle 106), and to execute navigation/routing functions necessary to follow the target vehicle. That is, in some aspects, a follow vehicle command may be generated and executed by AV 102.

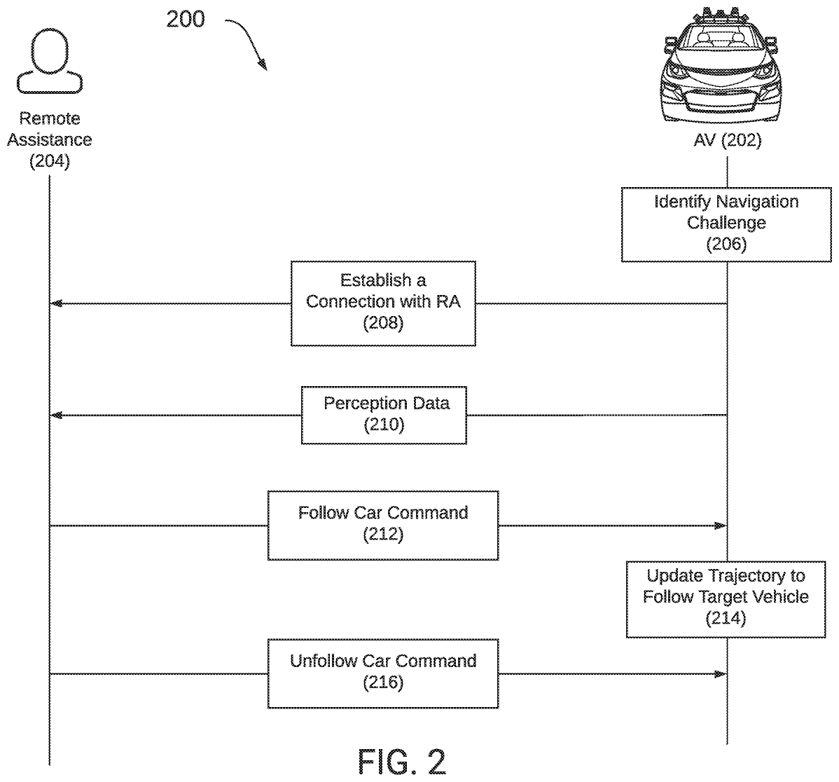

FIG. 2 illustrates a signaling diagram 200 of example communications between an AV 202 and a Remote Assistance (RA) system 204. At block 206, AV 202 identifies a navigation challenge. As discussed above with respect to FIG. 1, the navigation challenge may be caused by an encounter with a driving scenario (or unknown object) that cannot be easily navigated by AV 202. In some instances, AV 202 may be configured to identify the nature of the scenario/object that it cannot pass. For example, AV 202 may identify a difficult road construction scene that the AV's navigation software cannot reliably route around/through.

Based on the identified navigation challenge (block 206), AV 202 can establish a connection with a Remote Assistance (RA) system (block 208), for example, to initiate communication with an associated operator that can provide navigation assistance. Connection with the remote assistance system 204 enables an associated operator to provide instructions, such as navigation and routing instructions, to AV 202. To facilitate the operations of the RA operator, AV 202 can also be configured to provide perception/telemetry data (block 210), for example, that contains information about the nature of the AV's navigation challenge. As discussed above, perception data 210 can include sensor data, such as camera image data, Light Detection and Ranging (LiDAR) data, Radio Detection and Ranging (RADAR) data, etc., representing an environment around the AV, including one or more entities and/or traffic participants in the environment. By way of example, perception data 210 can include sensor data representing a driving scenario and/or obstruction (e.g., construction cones as discussed in relation to the example of FIG. 1) that is providing the navigation challenge. In some aspects, the perception data 210 may include telemetry that is computed by AV 202, including but not limited to kinematic information for one or more vehicles in the environment (e.g., velocity, acceleration, and/or location information, etc.), trajectory information, map context information, and/or semantic labeling information for surrounding objects.

To resolve the navigation challenge, the RA operator can send (e.g., via RA system 204) commands to AV 202, including a follow car command (block 212) that indicates a target vehicle and/or vehicle trajectory, that AV 202 should follow. Depending on the desired implementation, the follow car command may be based on inputs provided by an operator of RA system 204, for example, to indicate a specific vehicle that should be followed, and/or a particular path/route that AV 202 should navigate. In some aspects, follow car command 212 may indicate acceptance by the operator of a request originated by AV 202 to follow a specific vehicle. In such instances, AV 202 can be configured to select a vehicle or path/route to navigate, and provide a corresponding suggestion to the operator for approval.

In some aspects, the follow car command 212 may contain information specifying a route/path that the AV should follow, for example, based on historic route/paths taken by other vehicles that successfully navigated through/around the navigation challenge. Route/path information may be derived from or included within the telemetry information of perception data 210. For example, if the AV 202 observes multiple vehicles passing or circumnavigating the navigation challenge, then the path/s of those vehicles may be identified and followed, e.g., based on the follow car command. As such, the follow car command may contain instructions to follow a vehicle that is contemporaneously maneuvering around/through an environment shared by AV 202 or a path that was previously/historically navigated by vehicles no longer in the scene.

Depending on the desired implementation, the follow car command may be subject to certain constraints that define restrictions on areas and/or surfaces on which the AV may drive. For example, map context information stored (or received) by the AV may indicate drivable areas, such as by identifying roadways or lane segments to be traversed, and/or undrivable areas (e.g., sidewalks, bike paths, etc.), that cannot be traversed by AV 202. In some implementations, the follow car command may specify temporary or conditional permissions to drive on normally undrivable areas. By way of example, if AV 202 must traverse a private driveway to follow a route corresponding with a target vehicle, then traversal of the driveway may be permitted under special permissions granted by the operator of RA system 204.

Based on follow car command 212, AV 202 can update its trajectory (block 214) to begin following the indicated (target) vehicle, such as vehicle 106 discussed above in relation to the example of FIG. 1. In some aspects, AV 202 may be configured to follow the target vehicle until it receives an unfollow car command (block 216), from RA system 204, indicating that following should be stopped. In some aspects, AV 202 may be configured to automatically stop following the target vehicle, for example, after a predetermined timeout period, and/or if the target vehicle's trajectory deviates from the route plan of AV 202. By way of example, AV 202 may be configured to stop following the target vehicle if the target vehicle begins to proceed along a heading that is different from that indicated by the route plan for AV 202. As such, AV 202 can benefit from following the target vehicle up to a location where the target vehicle deviates from the route intended by AV 202.

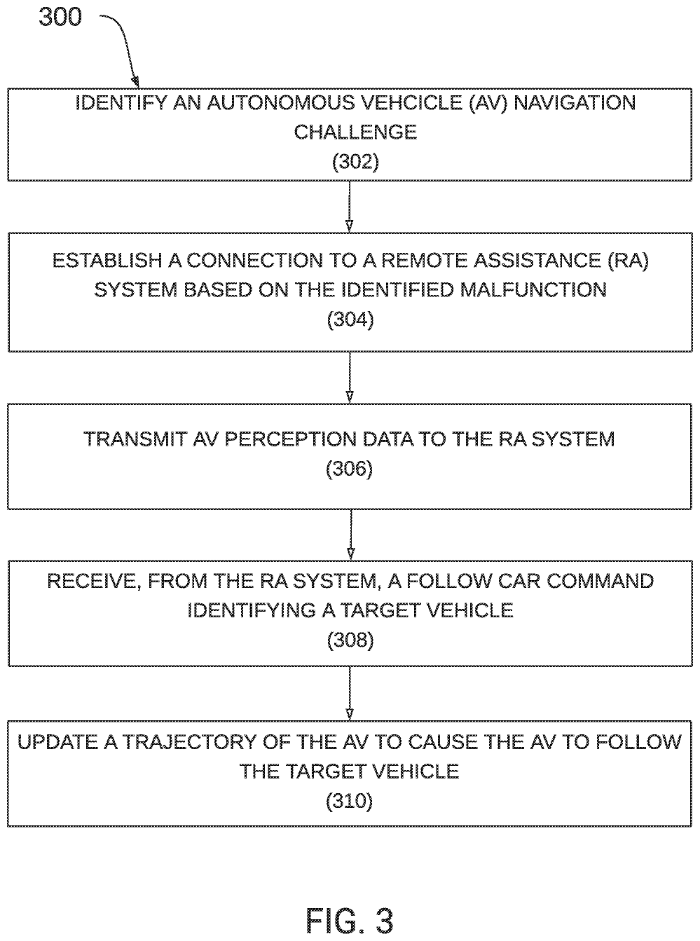

FIG. 3 illustrates an example process 300 for providing navigation assistance to an AV, such as AV 202, discussed above with respect to FIG. 1. At step 302, process 300 includes identifying an autonomous vehicle (AV) navigation challenge. The navigation challenge can result in cessation of AV navigation progress, i.e., resulting in a stuck vehicle. As discussed above, navigation challenges may occur as a result of AV encounters with novel or complex driving scenarios, unidentifiable objects, and/or other obstacles for which the AV perception, prediction, and/or planning functions generate errors.

At step 304, process 300 includes establishing a connection to a remote assistance (RA) system based on the identified challenge. The connection with the RA system (and operator) can be performed using any communication channels available to the AV, including but not limited to cellular connectivity channels and/or wireless internet (WiFi) connections, etc. As discussed above, connection to the RA system can be performed automatically by the AV, for example, when the AV identifies the occurrence of a navigation challenge. In some approaches, communication with the RA system may be automatically initiated upon the prior conditions identified by the AV, such as encounters with certain types of navigation challenge events (e.g., those associated with road construction events) or abnormally complex driving scenes, etc.

At step 306, process 300 includes transmitting AV perception data to the RA system, wherein the AV perception data includes sensor data representing one or more vehicles in an environment of the AV. In some aspects, AV perception data may include semantic data and/or metadata about objects in the environment, and/or the nature of the navigation challenge experienced by the AV. By way of example, the perception data may include representations of one or more objects, such as camera image data of vehicles/other traffic participants that are navigating a route that is the same as, or similar to, that of the AV. In some aspects, the perception data can include kinematic information for one or more objects, such as other traffic participants, including but not limited to location information, velocity information, acceleration information and/or predicted trajectory information, etc.

At step 308, process 300 includes receiving, from the RA system, a follow car command, wherein the follow car command identifies a target vehicle in the environment. As discussed above, the follow vehicle command may specify route/path information that can be used by the AV to follow the target vehicle. In some aspects, the follow vehicle command may include timeout information, for example, to indicate a duration of time that the AV should follow the target vehicle, such as for 30 seconds, 1 minute, or 5 minutes, etc., or length of a path to follow, such as for 1 meter, 5 meters, 20 meters, etc.

At step 310, the process 300 includes updating a trajectory of the AV to cause the AV to follow the target vehicle. The updated trajectory of the AV may be constrained by map data that indicates drivable and non-drivable areas, for example, so that the AV does not drive onto map regions that are not intended for vehicle passage. Depending on the desired implementation, the AV can continue to follow the target vehicle until an unfollow car command is received (such as unfollow car command 216, discussed above). In some implementations, the AV may be configured to automatically stop following the target vehicle, for example, after a predetermined time duration has elapsed, a predetermined length is traveled, and/or if a deviation in the trajectory of the target vehicle from the AV's destination routing information is detected.

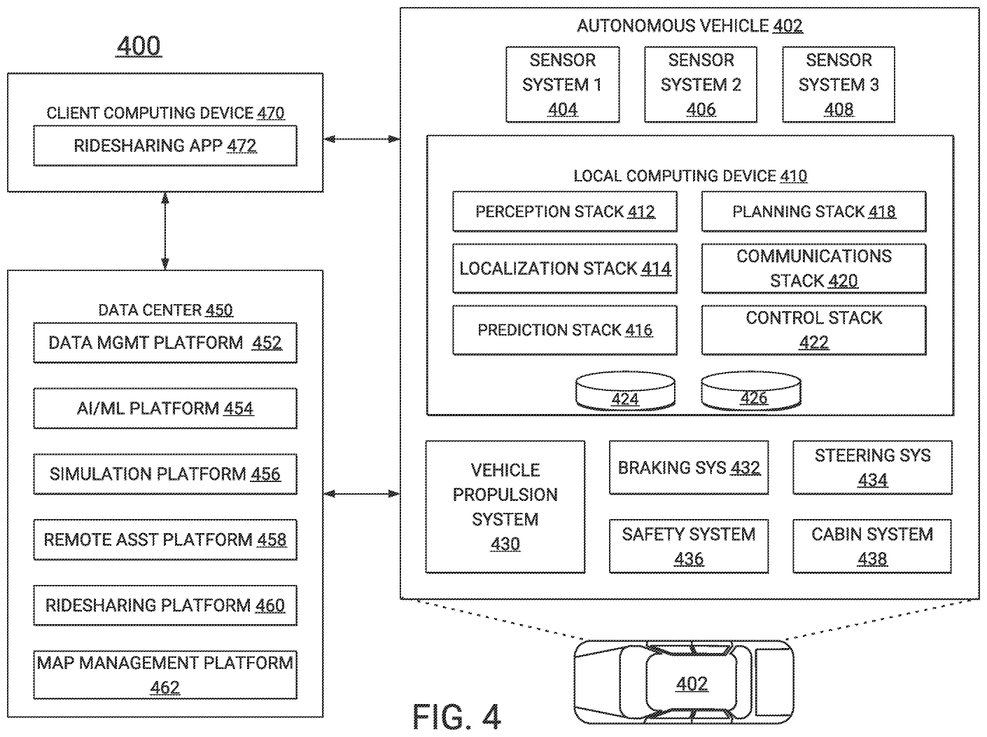

FIG. 4 is a diagram illustrating an example autonomous vehicle (AV) environment 400. One of ordinary skill in the art will understand that, for the AV environment 400 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include one or more types of sensors and can be arranged about the AV 402. For instance, the sensor systems 404-408 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other examples may include any other number and type of sensors.

The AV 402 can also include several mechanical systems that can be used to maneuver or operate the AV 402. For instance, mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some examples, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can identify environmental uncertainties, such as where to look for moving objects, flag areas that may be obscured or blocked from view, and so forth. In some examples, an output of the perception stack 412 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some cases, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some examples, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 426 can store HD maps and related data of the streets upon which the AV 402 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some examples, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 450 can include one or more computing devices remote to the local computing device 410 for managing a fleet of AVs and AV-related services. For example, in addition to managing the AV 402, the data center 450 may also support a ridehailing service (e.g., a ridesharing service), a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridehailing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridehailing platform 460, and a map management platform 462, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridehailing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridehailing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/MIL platform 454 or other system of the data center 450, the remote assistance platform 458 can prepare instructions for one or more stacks or other components of the AV 402.

The ridehailing platform 460 can interact with a customer of a ridehailing service via a ridehailing application 472 executing on the client computing device 470. The client computing device 470 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 472. The client computing device 470 can be a customer's mobile computing device or a computing device integrated with the AV 402 (e.g., the local computing device 410). The ridehailing platform 460 can receive requests to pick up or drop off from the ridehailing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridehailing platform 460 may incorporate the map viewing services into the client application 472 to enable passengers to view the AV 402 in transit en route to a pick-up or drop-off location, and so on.

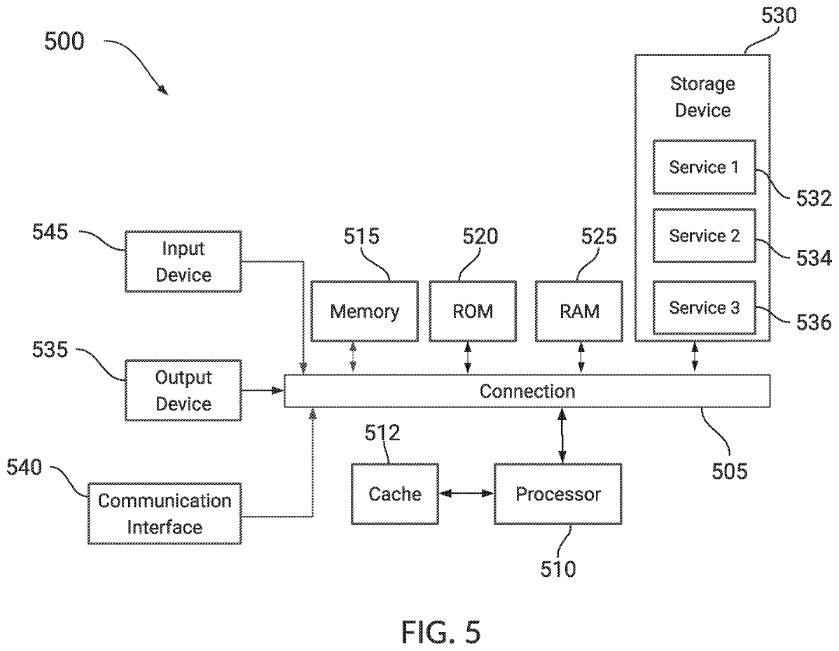

While the autonomous vehicle 402, the local computing device 410, and the autonomous vehicle environment 400 are shown to include certain systems and components, one of ordinary skill will appreciate that the autonomous vehicle 402, the local computing device 410, and/or the autonomous vehicle environment 400 can include more or fewer systems and/or components than those shown in FIG. 4. For example, the autonomous vehicle 402 can include other services than those shown in FIG. 4 and the local computing device 410 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 4. An illustrative example of a computing device and hardware components that can be implemented with the local computing device 410 is described below with respect to FIG. 5.

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be in both local and remote memory storage devices.

Exemplary aspects of the disclosed technology can include:

Aspect 1: An apparatus comprising: at least one memory; and at least one processor coupled to the at least one memory, the at least one processor configured to: identify an autonomous vehicle (AV) navigation challenge; establish a connection to a remote assistance (RA) system based on the identified challenge; transmit AV perception data to the RA system, wherein the AV perception data includes sensor data representing one or more vehicles in an environment of the AV; receive, from the RA system, a follow car command, wherein the follow car command identifies a target vehicle from among the one of the one or more vehicles in the environment; and update a trajectory of the AV to cause the AV to follow the target vehicle.

Aspect 2: The apparatus of aspect 1, wherein the processor is further configured to: receive, from the RA system, an unfollow car command, wherein the unfollow car command causes the AV to stop following the target vehicle.

Aspect 3: The apparatus of any of aspects 1-2, wherein the at least one processor is further configured to: automatically stop following the target vehicle if a trajectory of the target vehicle deviates from destination routing information associated with the AV.

Aspect 4: The apparatus of any of aspects 1-3, wherein the sensor data comprises camera image data representing the one or more vehicles in the environment.

Aspect 5: The apparatus of any of aspects 1-4, wherein the AV perception data comprises predicted trajectory information for the one or more vehicles.

Aspect 6: The apparatus of any of aspects 1-5, wherein to update the trajectory of the AV to cause the AV to follow the target vehicle, the at least one processor is configured to: select a path for navigating the AV toward the target vehicle, wherein the path is selected based on map context information indicating one or more drivable areas in the environment.

Aspect 7. The apparatus of any of aspects 1-6, wherein to update the trajectory of the AV to cause the AV to follow the target vehicle, the at least one processor is configured to: receive, from the RA system, a path for navigating the AV toward the target vehicle.

Aspect 8. A computer-implemented method comprising: identifying an autonomous vehicle (AV) navigation challenge; establishing a connection to a remote assistance (RA) system based on the identified challenge; transmitting AV perception data to the RA system, wherein the AV perception data includes sensor data representing one or more vehicles in an environment of the AV; receiving, from the RA system, a follow car command, wherein the follow car command identifies a target vehicle from among the one of the one or more vehicles in the environment; and updating a trajectory of the AV to cause the AV to follow the target vehicle.

Aspect 9: The computer-implemented method of aspect 8, further comprising: receiving, from the RA system, an unfollow car command, wherein the unfollow car command causes the AV to stop following the target vehicle.

Aspect 10: The computer-implemented method of any of aspects 8-9, further comprising: automatically stop following the target vehicle if a trajectory of the target vehicle deviates from destination routing information associated with the AV.

Aspect 11: The computer-implemented method of any of aspects 8-10, wherein the sensor data comprises camera image data representing the one or more vehicles in the environment.

Aspect 12: The computer-implemented method of any of aspects 8-11, wherein the AV perception data comprises predicted trajectory information for the one or more vehicles.

Aspect 13: The computer-implemented method of any of aspects 8-12, wherein updating the trajectory of the AV to cause the AV to follow the target vehicle, further comprises: selecting a path for navigating the AV toward the target vehicle, wherein the path is selected based on map context information indicating one or more drivable areas in the environment.

Aspect 14: The computer-implemented method of any of aspects 8-13, wherein updating the trajectory of the AV to cause the AV to follow the target vehicle, further comprises: receiving, from the RA system, a path for navigating the AV toward the target vehicle.

Aspect 15: A non-transitory computer-readable storage medium comprising at least one instruction for causing a computer or processor to: identify an autonomous vehicle (AV) navigation challenge; establish a connection to a remote assistance (RA) system based on the identified challenge; transmit AV perception data to the RA system, wherein the AV perception data includes sensor data representing one or more vehicles in an environment of the AV; receive, from the RA system, a follow car command, wherein the follow car command identifies a target vehicle from among the one of the one or more vehicles in the environment; and update a trajectory of the AV to cause the AV to follow the target vehicle.

Aspect 16: The non-transitory computer-readable storage medium of aspect 15, wherein the at least one instruction is further configured to cause the computer or processor to: receive, from the RA system, an unfollow car command, wherein the unfollow car command causes the AV to stop following the target vehicle.

Aspect 17: The non-transitory computer-readable storage medium of any of aspects 15-16, wherein the at least one instruction is further configured to cause the computer or processor to: automatically stop following the target vehicle if a trajectory of the target vehicle deviates from destination routing information associated with the AV.

Aspect 18: The non-transitory computer-readable storage medium of any of aspects 15-17, wherein the sensor data comprises camera image data representing the one or more vehicles in the environment.

Aspect 19: The non-transitory computer-readable storage medium of any of aspects 15-18, wherein the AV perception data comprises predicted trajectory information for the one or more vehicles.

Aspect 20. The non-transitory computer-readable storage medium of any of aspects 15-19, wherein to update the trajectory of the AV to cause the AV to follow the target vehicle, the at least one instruction is further configured to cause the computer or processor to: select a path for navigating the AV toward the target vehicle, wherein the path is selected based on map context information indicating one or more drivable areas in the environment.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus comprising:
at least one memory; and
at least one processor coupled to the at least one memory, the at least one processor configured to:
identify an autonomous vehicle (AV) navigation challenge;
establish a connection to a remote assistance (RA) system based on the identified challenge;
transmit AV perception data to the RA system, wherein the AV perception data includes sensor data representing one or more vehicles in an environment of the AV;
receive, from the RA system, a follow car command, wherein the follow car command identifies a target vehicle from among the one of the one or more vehicles in the environment; and
update a trajectory of the AV to cause the AV to follow the target vehicle.

2. The apparatus of claim 1, wherein the at least one processor is further configured to:
receive, from the RA system, an unfollow car command, wherein the unfollow car command causes the AV to stop following the target vehicle.

3. The apparatus of claim 1, wherein the at least one processor is further configured to:
automatically stop following the target vehicle if a trajectory of the target vehicle deviates from destination routing information associated with the AV.

4. The apparatus of claim 1, wherein the sensor data comprises camera image data representing the one or more vehicles in the environment.

5. The apparatus of claim 1, wherein the AV perception data comprises predicted trajectory information for the one or more vehicles.

6. The apparatus of claim 1, wherein to update the trajectory of the AV to cause the AV to follow the target vehicle, the at least one processor is configured to:
select a path for navigating the AV toward the target vehicle, wherein the path is selected based on map context information indicating one or more drivable areas in the environment.

7. The apparatus of claim 1, wherein to update the trajectory of the AV to cause the AV to follow the target vehicle, the at least one processor is configured to:
receive, from the RA system, a path for navigating the AV toward the target vehicle.

8. A computer-implemented method comprising:
identifying an autonomous vehicle (AV) navigation challenge;
establishing a connection to a remote assistance (RA) system based on the identified challenge;
transmitting AV perception data to the RA system, wherein the AV perception data includes sensor data representing one or more vehicles in an environment of the AV;
receiving, from the RA system, a follow car command, wherein the follow car command identifies a target vehicle from among the one of the one or more vehicles in the environment; and
updating a trajectory of the AV to cause the AV to follow the target vehicle.

9. The computer-implemented method of claim 8, further comprising:
receiving, from the RA system, an unfollow car command, wherein the unfollow car command causes the AV to stop following the target vehicle.

10. The computer-implemented method of claim 8, further comprising:
automatically stop following the target vehicle if a trajectory of the target vehicle deviates from destination routing information associated with the AV.

11. The computer-implemented method of claim 8, wherein the sensor data comprises camera image data representing the one or more vehicles in the environment.

12. The computer-implemented method of claim 8, wherein the AV perception data comprises predicted trajectory information for the one or more vehicles.

13. The computer-implemented method of claim 8, wherein updating the trajectory of the AV to cause the AV to follow the target vehicle, further comprises:
selecting a path for navigating the AV toward the target vehicle, wherein the path is selected based on map context information indicating one or more drivable areas in the environment.

14. The computer-implemented method of claim 8, wherein updating the trajectory of the AV to cause the AV to follow the target vehicle, further comprises:
receiving, from the RA system, a path for navigating the AV toward the target vehicle.

15. A non-transitory computer-readable storage medium comprising at least one instruction for causing a computer or processor to:
identify an autonomous vehicle (AV) navigation challenge;
establish a connection to a remote assistance (RA) system based on the identified challenge;
transmit AV perception data to the RA system, wherein the AV perception data includes sensor data representing one or more vehicles in an environment of the AV;
receive, from the RA system, a follow car command, wherein the follow car command identifies a target vehicle from among the one of the one or more vehicles in the environment; and
update a trajectory of the AV to cause the AV to follow the target vehicle.

16. The non-transitory computer-readable storage medium of claim 15, wherein the at least one instruction is further configured to cause the computer or processor to:
receive, from the RA system, an unfollow car command, wherein the unfollow car command causes the AV to stop following the target vehicle.

17. The non-transitory computer-readable storage medium of claim 15, wherein the at least one instruction is further configured to cause the computer or processor to:
automatically stop following the target vehicle if a trajectory of the target vehicle deviates from destination routing information associated with the AV.

18. The non-transitory computer-readable storage medium of claim 15, wherein the sensor data comprises camera image data representing the one or more vehicles in the environment.

19. The non-transitory computer-readable storage medium of claim 15, wherein the AV perception data comprises predicted trajectory information for the one or more vehicles.

20. The non-transitory computer-readable storage medium of claim 15, wherein to update the trajectory of the AV to cause the AV to follow the target vehicle, the at least one instruction is further configured to cause the computer or processor to:
select a path for navigating the AV toward the target vehicle, wherein the path is selected based on map context information indicating one or more drivable areas in the environment.
